(19) United States
(12) Patent Application Publication
(10) Pub. No.: US 2016/0266275 A1
(43) Pub. Date: Sep. 15, 2016

(54) METHODS FOR ESTIMATING FORMATION PARAMETERS

(71) Applicant: SCHLUMBERGER TECHNOLOGY CORPORATION, Sugar Land, TX (US)

(72) Inventors: Ridvan Akkurt, Lexington, MA (US); Se Un Park, Quincy, MA (US); Paul Ryan Craddock, Cambridge, MA (US)

(21) Appl. No.: 15/062,826

(22) Filed: Mar. 7, 2016

Related U.S. Application Data
(60) Provisional application No. 62/130,937, filed on Mar. 10, 2015.

(51) Int. Cl. G01V 8/10; E21B 49/00; G01V 11/00

(52) U.S. Cl. CPC G01V 8/10; G01V 11/002; E21B 49/00

(57) ABSTRACT

Techniques for quantifying minerals in a formation sample include using a joint inversion of DRIFTS (diffuse reflectance infrared Fourier transform spectroscopy) spectra and XRF (X-ray fluorescence) data. This joint inversion produces quantification of additional minerals (e.g. pyrite and barite) than those quantified by the individual inversion method (DRIFTS-only). The method is applied to oilfield reservoir samples and the mineralogy solution is compared to the DRIFTS-only solution and to mineralogy estimated from benchmark FTIR (transmission Fourier transform infrared spectroscopy) method.

### CROSS REFERENCE TO RELATED APPLICATION

This application claims benefits from U.S. Provisional Patent Application No. 62/130,937 filed Mar. 10, 2015, the contents of which are hereby incorporated herein by reference.

### FIELD

The subject disclosure generally relates to the field of characterization of earth formations traversed by a borehole. More specifically, this subject disclosure applies to identification and quantification of minerals and organic matter in oilfield reservoirs.

### BACKGROUND

Several methods are presently available for mineralogical analysis of geological materials such as drill core and cuttings. It is common practice to use these methods individually for the determination of mineral compositions in oilfield samples. Diffuse reflectance infrared Fourier transform spectroscopy (DRIFTS) is one spectroscopy method for the determination of mineral compositions in geological materials. Using DRIFTS, it is possible to quantify routinely the concentrations of, for example, elite, spectate, kaolinite, chlorite, muscovite, quartz plus feldspar, calcite, dolomite, and kerogen. The DRIFTS method is rapid and can be deployed at the wellsite for near real-time analysis of mineralogy in cuttings. X-ray fluorescence (XRF) spectroscopy is an analytical method for the quantification of elemental concentrations in geological samples. The XRF method can be deployed either in a remote laboratory setting or at the wellsite. XRF is the emission of characteristic “secondary” (or fluorescent) X-rays from a material that has been excited by bombarding with high-energy X-rays. The energy of the fluorescent X-rays is diagnostic of the atom, and hence element, from which the X-ray was emitted. Counting of the number of fluorescent X-rays emitted from a sample enables one to estimate the concentration of multiple elements (generally elements with atomic mass from Na to U) in that sample. XRF has been used successfully to estimate mineralogy in igneous sequences for many decades, but has had limited success in sedimentary formations with more complex mineralogy. In sedimentary formations, chemical methods such as XRF have been used principally for validating other mineralogical interpretations. Other techniques that have been used individually for mineral analysis include transmission Fourier transform infrared spectroscopy (FTIR), X-ray diffraction (XRD), and attenuated total reflection (ATR) spectroscopy.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a method for the quantification of minerals in formation samples comprises using a joint inversion of DRIFTS (diffuse reflectance infrared Fourier transform spectroscopy) spectra and XRF (X-ray fluorescence) data. This joint inversion produces quantification of additional minerals not easily quantified by the individual inversion method (DRIFTS-only). The method is applied to oilfield reservoir samples and the mineralogy solution is compared to the DRIFTS-only solution and to mineralogy estimated from benchmark FTIR (transmission Fourier transform infrared spectroscopy) method.

According to some embodiments, a method is described for analyzing samples from a subterranean rock formation. The method includes: receiving a physical sample of the rock formation obtained from a borehole traversing the rock formation; performing a first measurement technique that includes making a first measurement on at least a portion of the sample; performing a second measurement technique that includes making a second measurement on at least a portion of the sample; and detecting the presence of one or more elements or minerals in the sample based on a combination of the first and second measurement techniques, wherein the detecting is with greater accuracy than or would not have been possible using either the first or second measurement techniques alone. According to some embodiments, one or more elements or minerals in the sample are quantified with greater accuracy than would have been possible using either the first or second measurement techniques alone.

According to some embodiments, the rock formation is sedimentary hydrocarbon-bearing rock formation. According to some embodiments, the one or more elements or minerals includes one or more organic chemical compounds such as kerogen, oil and/or bitumen. According to some embodiments, the first measurement technique is DRIFTS spectroscopy and the second measurement technique is XRF spectroscopy. According to some other embodiments, the first and second measurement techniques are selected from a group consisting of: DRIFTS; XRF; transmission Fourier transform IR (FTIR) spectroscopy; attenuated total reflection (ATR or ATR-IR) spectroscopy; X-ray diffraction (XRD); mass spectrometry; inductively coupled plasma atomic emission spectroscopy/optical emission spectroscopy (ICP-AES, or ICP-OES); atomic absorption spectroscopy (AAS); and neutron activation analysis (NAA). According to some embodiments, the rock formation includes non-sedimentary rocks, such as igneous rocks and/or metamorphic rocks

According to some embodiments, more than two measurement techniques are used and combined to provide the detection and/or quantifying of the elements or minerals in the physical sample. According to some embodiments, the combination of the first and second measurement techniques includes a joint inversion of the first and second measurements. One or both of the first and second measurements can be inverted individually prior to the joint inversion. According to some other embodiments, the combination of the first and second measurement techniques is an inversion of data from the first measurement constrained by data from the second measurement.

According to some embodiments, the physical sample is collected from drill cuttings and/or core sampling. The method can be carried out at wellsite location in real-time during a drilling operation. According to some other embodiments, the method is carried out in a laboratory remote from the borehole location.

According to some embodiments, a system is described for analyzing a sample from a subterranean rock formation. The system includes: a first measurement system configured to perform a first measurement type on a physical sample of the rock formation obtained from a borehole traversing the rock formation; a second measurement system configured to perform a second measurement type on the physical sample; and a processing system configured to detect the presence of one or more elements or minerals in the sample based on a combination of a first measurement from the first measurement system and a second measurement from the second measurement system, wherein the detecting is with greater accuracy than or would not have been possible using either the first or second measurement systems alone.

Further features and advantages of the subject disclosure will become more readily apparent from the following detailed description when taken in conjunction with the accompanying drawings.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic diagram of a joint inversion framework using DRIFTS and XRF data types, according to some embodiments;

FIGS. 2A and 2B are a flow diagram illustrating aspects of a joint inversion of multiple data types to yield a consistent mineralogy solution, according to some embodiments;

FIG. 3 is a schematic diagram illustrating the extension of the proposed joint inversion framework to further data types, according to some embodiments;

FIGS. 4A-4B, 5A-5B, 6A-6B and 7A-7B are plots showing results of a case study comparing results from a joint inversion techniques and conventional single system inversions, according to some embodiments; and

FIG. 8 illustrates a wellsite system in which elements and/or minerals in a hydrocarbon-bearing rock formation are quantified using multiple data types measured on samples taken from the well, according to some embodiments.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

According to some embodiments, a general framework is described for more extensive and accurate estimation of mineral compositions of earth formations by simultaneously analyzing two or more different data types. A framework for joint inversion of different types of data is for improved determination of formation properties.

Following is a description of some of the types of data which can be simultaneously analyzed, for example by joint inversion for improved formation evaluation.

DRIFTS is a spectroscopy method for the determination of mineral compositions in geological materials. See e.g., Char sky, A. M. Herron, M. M., “Quantitative analysis of kerogen content and mineralogy in shale cuttings by diffuse reflectance infrared Fourier transform spectroscopy,” International Symposium of the Society of Core Analysts, Paper SCA2012-27, 2012, hereinafter “Charsky”. Infrared light illuminating a sample powder is scattered by the sample grains in a manner dependent upon the bulk properties of the sample material. The recorded diffuse-reflection spectrum can be inverted for sample composition using previously measured pure mineral reflection spectra. The measurement can be made on loose sample powders without the need for micronizing or pressing of the sample into a pellet as may be required by other infrared spectroscopy methods. This method has been developed recently for characterization of mineralogy in geological samples including cores and cuttings. See e.g., Herron, M. M., Loan, M. L., Char sky, A. M., Herron, S. L., Pomerantz, A. E., Polyakov, M., Kerogen, “Content and Maturity, Mineralogy and Clay Typing from DRIFTS Analysis of Cuttings or Core”, Petrophysics, 55(5), 435-446, hereinafter “Herron”; and C. Hanson, R., “Solving Least Squares Problems”, Englewood Cliffs, N.J. Prentice-Hall, 1974, hereinafter “Hanson.”

The DRIFTS method has the following observation model:

b=A₀x+n₁, (1)

where x is an unknown vector (the solution) whose entries are proportional to the sample mineral weight fractions, A₀ has columns, a⁰ⱼ, of DRIFTS mineral standard spectra corresponding to the indices of x, b is a measured DRIFTS spectrum, and n₁ is noise. A DRIFTS mineral standard spectrum is the spectrum collected on a pure mineral. Note that the entries of x may be different from the exact mineral fractions due to possible amplification or attenuation of the measurement b. We denote the original DRIFTS system matrix by A₀ to differentiate it from A, the DRIFTS-originated submatrix of the joint matrix combining DRIFTS and chemical data that we introduce later herein. A traditional inversion method to evaluate the unknown mineral weight fractions in equation (1) is to minimize the Euclidean distance between b and A₀x with respect to x. See Hanson. The non-negativity constraint can be applied to the solution to produce physically meaningful results. If no constraints are applied, then it is reduced to a least-square solution.

It is possible to quantify routinely the concentrations of illite, smectite, kaolinite, chlorite, muscovite, quartz plus feldspar, calcite, dolomite, and kerogen. See Charsky and Herron. Kerogen is solid organic matter in sedimentary formations that is the precursor to petroleum during burial and heating over millions of years. The DRIFTS method is rapid and can be deployed at the wellsite for near real-time analysis of mineralogy in cuttings. DRIFTS is used in this subject disclosure as one embodiment of the joint inversion method for improved quantitative mineralogical determinations.

XRF spectroscopy is an analytical method for the quantification of elemental concentrations in geological samples. The XRF method can be deployed either in a remote laboratory setting or at the wellsite. XRF is the emission of characteristic “secondary” (or fluorescent) X-rays from a material that has been excited by bombarding with high-energy X-rays. The energy of the fluorescent X-rays is diagnostic of the atom, and hence element, from which the X-ray was emitted. Counting of the number of fluorescent X-rays emitted from a sample enables one to estimate the concentration of multiple elements (generally elements with atomic mass from Na to U) in that sample. See Bertin, E. P., Principles and Practice of X-ray Spectrometric Analysis. Springer, 1975, hereinafter “Bertin.” It may be possible to estimate the mineralogy of a sample from the elemental concentrations by inverting for mineral concentrations using known or assumed elemental concentrations of the individual minerals present in the sample. This method has been used successfully in igneous sequences for many decades, but has had limited success in sedimentary formations with more complex mineralogy. Principally, chemical methods such as XRF have been used for validating mineralogical interpretations of sedimentary formations obtained by other mineral analysis methods. See Herron S. L., Herron, M. M., Pirie, I., Saldungaray, P., Craddock, P. R., Charsky, A., Polyakov, M., Shray, F., Li, T., “Application and quality control of core data for the development and validation of elemental spectroscopy log interpretation”, Petrophysics, 55(5), 392-414, hereinafter “Herron 2.”

FTIR has been used for quantitative determination of mineral compositions in oilfield drill core and/or cuttings samples for at least twenty years. See Matteson, A., Herron, M. M., “Quantitative mineral analysis by Fourier transform infrared spectroscopy”, Society of Core Analysts Conference, Paper 9308, 1993, hereinafter “Matteson and Herron”; and Herron M. M., Matteson, A., Gustayson, G., “Dual-range FT-IR mineralogy and the analysis of sedimentary formations”, Proceedings of the International Symposium of the Society of Core Analysts, Paper SCA-9729, 1997, hereinafter “Herron 3”. One approach for quantitative mineralogy is to solve the FTIR absorption spectrum of the unknown sample as a weighted combination of absorption spectra representing known mineral standards. Development of this analytical technology now enables quantification of over twenty minerals common in oilfield samples (e.g., quartz, chert, albite, anorthite, potassium feldspar, calcite, dolomite, ankerite, illite, smectite, kaolinite, chlorite, pyrite, anhydrite, gypsum, among others) with an average accuracy better than two weight percent, making this method one of the most accurate available.

ATR is a sample analysis technique that can be combined with infrared (IR) spectroscopy to provide mineralogical characterization of geological materials within minimum sample preparation. The method works by measuring changes in the properties of a totally internally reflected IR beam coming into contact with a sample. See Fahrenfort, J., “Attenuated total reflection: A new principle for the production of useful infra-red reflection spectra of organic compounds”, Spectrochimica Acta, 17, 698-709, hereinafter “Fahrenfort.” The incident IR beam is directed into an ATR crystal with a high refractive index, such that the IR beam reflects at least once off the internal surface of the ATR crystal in contact with the sample. The total internal reflectance of the IR beam creates a wave that travels into the sample (depth of penetration ˜5 μm or less) at the crystal-sample contact. This wave is attenuated at the frequencies at which the sample absorbs energy. The perturbed wave is returned to the crystal, and exits the opposite end of the crystal with the IR beam and is detected by an IR spectrometer. Analogous to other IR spectroscopy techniques, the properties of the detected ATR-IR spectrum are diagnostic of the properties of the sample through which the beam has traveled. The limited path length of the evanescent wave into the sample dictates that the sample and ATR crystal have intimate contact. An advantage, therefore, is minimum distortion of the IR spectrum by a surrounding absorbing medium such as air, CO₂, H₂O, etc.

XRD is an analytical technique for mineralogical characterization of geological materials. XRD exploits the properties of crystalline materials that act as diffraction gratings for X-rays with wavelengths similar to the planar spacing of crystal lattices (i.e., minerals) in solid materials. The X-rays are reflected from the sample, with some incident upon an X-ray detector. The resulting X-ray spectrum is interpreted as a diffraction pattern. The diffraction pattern yields X-ray counts plotted as a function of diffraction angle. The position of the X-ray peaks identifies the crystalline materials and the amplitude of the X-ray peaks can be quantitatively related to the concentration of the crystalline materials. The principal limitation of XRD is the difficulty or inability to properly characterize poorly-crystalline or non-crystalline (amorphous) materials, because these materials do not have a regularly-occurring crystal lattice. In effect, the quantitative characterization of clay minerals is difficult and the characterization of organic matter (amorphous structure, including kerogen) is practically impossible.

According to some embodiments, a method for the quantification of minerals in a formation samples comprises using a joint inversion of DRIFTS spectra and XRF data. This joint inversion produces improved accuracy of mineral quantification and additional minerals (including pyrite and barite) can be quantified by a DRIFTS-only individual inversion method. The method is applied to oilfield reservoir samples and the mineralogy solution is compared to the DRIFTS-only solution and to mineralogy estimated from benchmark FTIR (transmission Fourier transform infrared spectroscopy) method.

The described joint solution exploits advantages of each measurement type and can achieve the following improvements: (1) quantifies additional minerals, such as pyrite and barite, compared to the mineral set derived from the individual inversion (i.e., DRIFTS only) without degrading overall accuracy, (2) in some cases reduces uncertainty of the mineralogical compared to the solution derived from singular measurements, and (3) provides a general framework that can be extended to include other types of data in addition to DRIFTS and XRF.

Both DRIFTS and XRF measurements can be performed at the wellsite and, thus, the described techniques can be readily applied at a wellsite to characterize drill cuttings while drilling in near real-time. Mineralogy obtained from the described inversion can further be used for well placement and reservoir characterization during drilling operations.

According to some embodiments, the joint inversion techniques can be applied in a remote laboratory where additional and more accurate/complex characterization methods can be included in the joint inversion framework to provide better accuracy and resolution of the sample mineralogy and/or other formation properties.

FTIR has been used extensively for the quantitative estimation of mineral concentrations in geological materials. The method is time-consuming, requiring labor-intensive sample preparation including sample grinding and dilution within an infrared-transparent matrix such as KBr powder. This method is limited to the laboratory and offers mineralogy information several days to weeks after collection of the sample such as from drill core or cuttings. The principal advantage of the FTIR method is the level of accuracy achievable, which is two weight percent on average for over twenty minerals common in oilfield formations.

There is an industry need for rapid (i.e., near-real time, within one to several hours of drilling) characterization of samples recovered from oilfield formations traversed by a borehole. Rapid formation evaluation has potential benefits in well completion decisions, for example, for the optimal placement of perforations and hydraulic fractures. There may also be potential applications for geosteering. DRIFTS was recently introduced as an analytical technique able to provide rapid and quantitative estimations of the most common minerals in oilfield formations including, smectite, illite, kaolinite, chlorite, quartz plus feldspar, muscovite, calcite, and dolomite. See Charsky. The technique can be used at a wellsite on cuttings recovered from a borehole and is able to provide mineralogy estimates within 20 minutes of collection. The accuracy of mineral quantification by this method is shown to be five weight percent. DRIFTS can also quantify kerogen with an accuracy on average of one weight percent.

The value of DRIFTS can be significantly increased by expanding the suite of quantifiable minerals and by improving accuracy of the measurement. The addition of certain minerals can be achieved by taking the elemental concentrations of a sample into account. For example, presence of sulfur in a sample indicates that it may contain minerals including pyrite, anhydrite, gypsum, and barite. If the amount of iron, calcium, and barium is also known, the concentration of these minerals can be accurately determined. Common elemental concentrations of various minerals are listed in Table 1. Additionally, uncertainty of the DRIFTS mineral solution may be reduced if the elemental concentrations of a sample are known and can be used as a constraint on the mineral abundances. One method available at the wellsite for measurement of elemental concentrations is XRF spectroscopy. The combination of data from two or more analytical methods provides a general framework to improve the characterization of geological samples.

TABLE 1
Representative elemental concentrations of
selected minerals in earth formations

| | Element concentration (wt %)\hat{ } | | | | | | | | | |
|---|---|---|---|---|---|---|---|---|---|---|
| Mineral Name | Si | Al | Ca | Mg | Fe | K | Na | Ba | C | S |
| Quartz | 46.7 | | | | | | | | | |
| Calcite | | | 40.1 | | | | | | 12.0 | |
| Dolomite | | | 21.7 | 13.2 | | | | | 13.0 | |
| Illite* | 25.3 | 9.0 | | 1.9 | 1.4 | 6.0 | | | | |
| Smectite* | 20.5 | 9.8 | 0.7 | | | | 0.8 | | | |
| Kaolinite | 21.8 | 20.9 | | | | | | | | |
| Chlorite* | 12.1 | 10.6 | | 10.5 | 17.8 | | | | | |
| Muscovite* | 21.1 | 20.3 | | | | 9.8 | | | | |
| Pyrite | | | | | 46.6 | | | | | 53.4 |
| Barite | | | | | | | | 58.8 | | 13.7 |

\hat{ }Concentrations reported in weight percent for select elements. The remaining mass balance is accommodated principally by oxygen, together with minor concentrations of other elements (e.g., Ti, P, H)
*Minerals with known varying chemical composition; reported concentrations illustrate one of several possible compositions

According to some embodiments, a number of improvements can be provided. First, additional minerals are quantified, such as pyrite and barite, which are not quantified by the existing DRIFTS-only analysis. Second, uncertainty of the determined mineral content compared to the results obtained from individual inversion of DRIFTS data is minimized. Third, the joint inversion can include other characterization methods that can further reduce uncertainty and extend the quantifiable mineral set.

According to some embodiments, methods are described that improve mineralogy estimates in geological samples using a joint inversion of DRIFTS and XRF data.

The individual inversion of DRIFTS spectra to estimate mineralogy follows the model described by Eq. (1). An analogous model can be established for XRF data, before a joint inversion for DRIFTS and XRF data is formulated. An XRF model is formulated as follows:

d=F₀y+n₂ (2)

where d is the weight fractions of elements measured by XRF spectroscopy, y is an unknown vector of the mineral weight fractions (i.e., the solution containing the calculated mineral weight fractions in the unknown samples), F₀ is a matrix with columns, fⱼ⁰, specifying the element weight fractions of the minerals corresponding to the indices of y, and n₂ is noise. The original XRF system matrix is denoted by F₀ to differentiate it from F, the XRF-originated submatrix of the joint system matrix combining DRIFTS and XRF that we introduce later in this subject disclosure.

Unlike DRIFTS, the individual inversion using XRF data to produce mineralogy is not successful. This is because the XRF system matrix is ill-conditioned or close to a singular matrix. Therefore, this individual inversion approach results in unreliable or non-unique solutions for mineralogy. However, combined with DRIFTS data in a simultaneous inversion approach, the solution will be improved. This is partly due to chemical XRF results being more accurate than the mineralogy estimate from DRIFTS-alone analysis in terms of their individual observed variances in weight percentages. Moreover, certain elements from XRF analysis, being so-called “diagnostic elements”, provide a method to quantify certain minerals, such as but not limited to pyrite and barite.

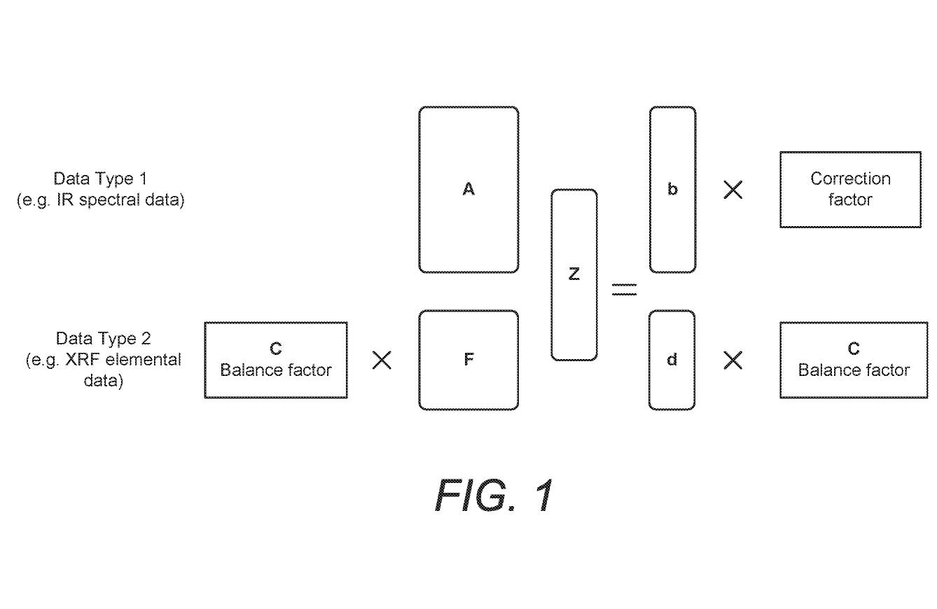

FIG. 1 is a schematic diagram of a joint inversion framework using DRIFTS and XRF data types, according to some embodiments. In FIG. 1, A is a matrix that contains DRIFTS mineral standard spectra in columns form, b is the measured DRIFTS spectrum of an unknown sample, F is a matrix that links mineral composition of a sample to its elemental concentrations, d is the vector of XRF-determined element concentrations in the unknown sample, and z is the solution (mineral composition of the unknown sample) to the joint inversion.

According to some embodiments, to merge the two systems, four disparities between them are resolved:

1.1 Different Sets of Solved Minerals Between Different Sets of Data.

The first disparity is that the two unknowns x and y represent different sets of minerals. For example, x from DRIFTS does not have components for pyrite or barite, and y from XRF does not have components for kerogen. In addition to the difference of the mineral coverage, the DRIFTS system matrix A₀ can have multiple standard spectra for the same type of mineral. For example, there can be more than one type of illite and more than one type of kerogen.

1.2 Magnitude Disparity.

The second disparity is the difference in magnitude of the numbers in the DRIFTS and XRF systems. The numbers in F₀ and y are fractional ε[0,1] and the numbers in A₀ and b can be on the order of 10⁵. Also, the number of rows of F₀, typically between 10 and 20, is much smaller than that of A₀, which is typically much greater than 1000.

1.3 Scaling of DRIFTS Spectrum.

While the shape of a DRIFTS spectrum is defined by the mineralogical composition of the sample, its overall amplitude can fluctuate from one observation to another. The relative proportions of the x vector components are preserved since the shape of the DRIFTS spectrum does not change; however, the absolute magnitude of the values in the DRIFTS solution vector x may vary. Thus, the components of the vector x do not equate to the absolute mineral weight fractions, but rather represent quantities proportional to them. In effect, x does not sum to one. At the same time, the components of the vector y are equal to the mineral weight fractions. This implies that the estimate in Eq. (1) should be compensated by a positive real number as a scale factor since a DRIFTS spectrum b can be regarded as an amplified or attenuated version of the A₀x₀ where x₀ is the exact mineral fractions.

1.4. Consistency Between Two Individual Solutions.

The fourth disparity is the difference between the solutions for minerals common between the two systems. We assume the joint solution, denoted by z, to be the union of the two solutions so that z represents mineral weight fractions for all quantifiable minerals from DRIFTS or XRF. The part solutions x and y can then be considered as the subvectors of z. These two subvectors should be consistent with each other; the illite fraction from x should be the same as the illite fraction from y.

According to some embodiments, the following solutions are used to the above-described disparities.

2.1 Different Sets of Solved Minerals.

The sets of minerals quantifiable individually from DRIFTS and XRF are different. Thus, the A₀ and F₀ matrix are not compatible; in effect, column k in A₀ may present a different mineral to that in column k in F₀. The discrepancy is resolved by expanding the individual system matrices (A₀ and F₀) to produce compatible A and F. A is an extended version of A₀ and can have columns of zeros if there are no corresponding minerals in A₀, such as pyrite. F is constructed such that it has all columns in F₀ and also columns of zeros if there is no corresponding mineral in F₀, such as kerogen. F can have duplicate columns from F₀ if there are two different spectral standards for the same mineral. For example, two calcite minerals may have different spectra, but have the same elemental concentrations, so the corresponding two columns of F are the same. The matrices A and F have the same number of columns and the corresponding columns of A and F reference the same mineral.

For example, one may have individual system matrices A₀=[a₁, a₂, a₃, a₄] and F₀=[f₁, f₂, f₃], where a₁ is a DRIFTS standard spectrum for kerogen, a₂ for calcite1, a₃ for calcite2, a₄ for illite; and f₁ is an element weight fraction of calcite, f₂ for illite, and f₃ for pyrite. The discrepancy is resolved by expansion of A₀ and F₀ to yield A=[a₁, a₂, a₃, a₄, 0] and F=[0, f₁, f₁, f₂, f₃].

2.2 Magnitude Disparity.

A solution to the second disparity as noted above is to add a positive real number c as a weight/balancing factor for XRF, i.e.,

$$[ \begin{matrix}b \\ c d\end{matrix} ] = [ \begin{matrix}A \\ cF\end{matrix} ] z + n \qquad ( 3 )$$

where z is the vector of unknown mineral weight fractions to be solved and n is noise. n is augmented noise from both DRIFTS and XRF measurements. c can be calculated as a ratio of the estimated noise level of DRIFTS data to the estimated noise level of XRF data. The assumption behind this estimation is that noise magnitude of each measurement is comparable to the corresponding measurement magnitude. The noise level in DRIFTS can be estimated by calculating the misfit (i.e., the Euclidean distance ∥b−A\hat{x}∥²) between the measured spectrum (b) and the fit to the spectrum (A\hat{x}). The fit can come from ground-truth mineralogy (e.g., FTIR) or be calculated from the DRIFTS mineralogy solution. The noise level in XRF can be similarly estimated by calculating the misfit (i.e., the Euclidean distance ∥d−Fŷ∥²) between the measured element weight fraction and the fit to the XRF data (Fŷ) from a mineralogy solution.

2.3 Scaling of DRIFTS Spectrum.

To address this disparity, a correction to the DRIFTS data is made using spectral amplification or attenuation. A compensating factor L is proposed that enforces Σᵢxᵢ≈1 and a rescaled DRIFTS spectrum Lb is used instead of b, i.e.,

Lb=A₀x+n₁

Several methods are proposed to estimate L. \hat{x} is defined to be a least-square solution in the DRIFTS system equation with the positivity constraint x, such that:

$$\hat{x} = arg {min}_{x} ‖ {A}_{0} x - Lb ‖ \qquad ( 4 )$$

Method 1.

In the first method, one can guess the value for L to satisfy the condition:

$${\sum }_{i} {\hat{x}}_{i} \approx 1.$$

This value is proposed to be:

$${L}_{0} = \frac{1}{\sum {x}_{i }^{0}} , \qquad ( 5 )$$

where

$${x}^{0} = arg {min}_{x} ‖ {A}_{0} x - b ‖ ,$$

and x⁰ is the solution (vector of relative mineral weight fractions) estimated from the uncompensated DRIFTS measurements.

Method 2.

In the second method, one can estimate L such that:

$${\sum }_{i} {\hat{x}}_{i} = 1. \qquad ( 6 )$$

Method 3.

For the third method, L can be estimated such that:

$${\sum }_{i} {\hat{x}}_{i} = 1 - ɛ , \qquad ( 7 )$$

where ε is the sum of missing mineral weight fractions not solved by DRIFTS (e.g., sum of pyrite and barite). Thus, ε accounts for, at minimum, the missing weight fraction of minerals not solved by DRIFTS. This missing fraction ε is not known a priori, but can be estimated, for example, using the elemental weight concentrations from XRF measurements and the known elemental concentrations of minerals not solved by DRIFTS. Details on how to compute ε are given below.

If it is not possible to calculate the value of E, then we use the following inequality to constrain L that guarantees:

$${\sum }_{i} {\hat{x}}_{i} < 1. \qquad ( 8 )$$

Method 4.

In some cases, it is possible to partially estimate ε (i.e., estimate the weight fractions of some missing minerals, ε₁). However, there may exist an uncaptured missing weight fraction, ε₂, wherein ε=ε₁+ε₂. In this case, we use the following inequality to constrain L that guarantees:

$${\sum }_{i} {\hat{x}}_{i} < 1 - {ɛ}_{1} . \qquad ( 9 )$$

The value of ε can be estimated by using elemental concentrations of the sample obtained from XRF measurements, combined with knowledge of the elemental concentrations of minerals not solved by DRIFTS. If we define M to be the set of suspected missing minerals in DRIFTS, then we have:

$$\begin{matrix}ɛ = {\sum }_{m ε ℳ} \frac{molecular weight of m }{molecular weight of characteristic element in m} . \\ ( weight ratio of characteristic element of XRF data ) & ( 10 ) \\ ɛ = {\sum }_{m εℳ} \frac{weight \% of characteristic element in XRF data}{weight \% of characteristic element in m} & ( 11 )\end{matrix}$$

For example, sulfur can be characteristic for pyrite. Considering this mineral, Eq. (10) can be written as:

$$\begin{matrix}ɛ = \frac{weight percent of sulfur in XRF data}{weight percent of sulfur in pyrite ( {FeS}_{2} )} = \frac{weight percent of sulfur in XRF data}{53.45} & ( 12 ) \\ ɛ = \frac{weight percent of barium in XRF data}{weight percent of barium in barite ( {BaSO}_{24} )} = \frac{weight percent of barium in XRF data}{58.84} & ( 13 )\end{matrix}$$

The accuracy with which ε can be determined is dependent upon the proficiency of the XRF data to identify and quantify those minerals not solved by DRIFTS.

By combining the compensation factor L with the compensations in 2.1 and 2.2 above, in a joint inversion of two data types, we obtain the following model equation:

$$[ \begin{matrix}Lb \\ c d\end{matrix} ] + [ \begin{matrix}A \\ cF\end{matrix} ] z + n , \qquad ( 14 )$$

where again c is the weight/balance factor applied to XRF data, n is noise, and z is the vector of unknown mineral weight fractions to be solved.

2.4 Inconsistency Between Two Individual Solutions.

We expect the solution to be consistent between two or more set of measurements, for example between DRIFTS and XRF. For instance, illite fraction in x should be close to the illite fraction in y. Using this logic, we can derive a scaling factor M by comparing the ratio of x to y. To better differentiate this compensation factor from the compensating factor L in 2.3 above, we apply this scalar to the XRF data. We call this compensation a ‘solution matching’ method. For the purposes of deriving M here, the compensation factor L is neglected. Inclusion of L in the solution below using M can be done simply by replacing b with Lb. In this case, the model equation including Min combination with the compensations in 2.1. and 2.2. is:

$$[ \begin{matrix}b \\ cMd\end{matrix} ] = [ \begin{matrix}A \\ cF\end{matrix} ] z + n , \qquad ( 15 )$$

where M has to be estimated. First, we present an example of how M is estimated on a synthetic example case, where observations are constructed from known x and y. Thereafter, we provide the general formulation to estimate M.

Estimating M Using a Synthetic Example.

We demonstrate how to find M, beginning with the individual DRIFTS and XRF system models (Eqs. 1 and 2). In this example, the noise associated with the two systems is neglected. We construct the data starting with known x, y:

b=A₀x=[a₁,a₂,a₃,a₄]x (16)

d=F₀y=[f₁,f₂,f₃]y (17)

where a₁ is a DRIFTS standard spectrum for kerogen, a₂ for calcite1, a₃ for calcite2, a₄ for illite; f₁ is the vector of element weight fractions for calcite, f₂ for illite, f₃ for pyrite; x=[x₁, x₂, x₃, x₄]^{T}, y=[y₁, y₂, y₃]. Then we can rewrite the above equations as:

$$b = Az = [ \begin{matrix}{a}_{1} & {a}_{2} & {a}_{3} & {a}_{4} & 0\end{matrix} ] [ \begin{matrix}x \\ 0\end{matrix} ]$$

$$d = F \frac{z}{M} = [ \begin{matrix}0 & {f}_{1} & {f}_{1} & {f}_{2} & {f}_{3}\end{matrix} ] [ \begin{matrix}0 \\ {ty}_{1} \\ ( 1 - t ) {y}_{1} \\ {y}_{2} \\ {y}_{3}\end{matrix} ]$$

for a fixed tε[0,1]. The merged equation is (ignoring c in Eq. (15) for this construction):

$$[ \begin{matrix}{a}_{1} & {a}_{2} & {a}_{3} & {a}_{4} & 0 \\ 0 & {f}_{1} & {f}_{1} & {f}_{2} & {f}_{3}\end{matrix} ] z = [ \begin{matrix}b \\ Md\end{matrix} ] \qquad ( 18 )$$

where z=[z₁, z₂, z₃, z₄, z₅], and z₁ is the solution for kerogen, z₂ is for calcite 1, z₃ is for calcite 2, z₄ for illite, and z₅ is for pyrite. By construction, we let zᵢ=xᵢ for i=1, 2, 3, 4, satisfying the upper part of the equation. The lower part becomes:

f₁(x₂+x₃)+f₂x₄+f₃z₅=Md. (19)

Since we assume a consistent solution for both equations, comparing Eqs. (18) and (22) gives:

$$\begin{matrix}M = \frac{{x}_{2} + {x}_{3}}{{y}_{1 }} = \frac{{x}_{4}}{{y}_{2}} & ( 20 ) \\ {z}_{5} = {My}_{3} . & ( 21 )\end{matrix}$$

Practical Estimation of M Using a Synthetic Example.

In practice, the individual solutions from noisy measurements do not give the same M value for different minerals. In such a case, we need to estimate M among several values of Mₖ, where k is an index of common minerals. First, we choose a subset of the common minerals to evaluate M This subset can be determined before evaluating M if we have prior knowledge about which mineral fractions obtained from the individual inversion can be reliably used. Another way to determine this subset from the common mineral set is to exclude minerals whose Mₖ are outliers among the whole set of Mₖ. For example, assume that the individual solutions from corresponding noisy measurements are X=[x_{kerogen}, x_{calcite1}, x_{calcite2}, xᵢₗₗᵢₜₑ, x_{dolomite}], y=[y_{calcite}, yᵢₗₗᵢₜₑ, y_{dolomite}, y_{pyrite}]. Let x=[0.05, 0.3, 0.25, 0.55, 0.1] and y=[0.5, 0.45, 0.03, 0.02], where x and y are determined from their individual inversions and the sum of x does not equal one. If we choose calcite and illite to estimate M value, then M from calcite is,

$$M = \frac{{x}_{calcite 1} + {x}_{calcite 2}}{{y}_{calcite}} = \frac{0.3 + 0.25}{0.5} = 1.10$$

and from illite is,

$$M = \frac{{x}_{illite}}{{y}_{illite}} = \frac{0.55}{0.45} = 1.22 .$$

The value of M calculated from dolomite is 3.33 (i.e., 0.1/0.03) and so is excluded as an outlier. The representative value for M can be obtained by evaluating the mean or median of the chosen M values. In this example, the mean is (1.10+1.22)/2=1.16. We can use this value for M. The procedure of estimating M can be performed again iteratively after the joint inversion. In this case, the x and y are obtained from the joint solution z by using mapping functions l and m, introduced below in the general solution.

General Solution for Estimating M.

The general estimation procedure for M is as follows, after defining index sets for common minerals in each system:

I₁: the set of indices of common minerals between DRIFTS and XRF in terms of indices of the mineral vector in the spectral (DRIFTS) system,
I₂: the set of indices of common minerals between DRIFTS and XRF in terms of indices of the mineral vector in the chemical (XRF) system,
I: the set of indices of common minerals between DRIFTS and XRF in terms of indices of the mineral vector in the joint system.
For example, common minerals between DRIFTS and XRF currently include, but are not limited to, calcite, dolomite, quartz, and illite. By assuming consistent solutions for both systems, we can derive a condition. For an index i representing specific mineral K and iεI₂,

$${y}_{i} = {\sum }_{j ∈ {I}_{1} ( K )} \frac{{x}_{j}}{{‖ {x}_{{I}_{1}} ‖}_{1}} \qquad ( 22 )$$

where ∥·∥₁ is an I₁ norm, I₁(K) is a set of indices that correspond to mineral K in I₁, x₁, or an arbitrary index set I is defined to be a vector of xⱼ for jε [symbol] . Eq. (22) ensures that the relative proportions of common minerals between DRIFTS and XRF are the same (consistent).

To produce the general formula, we first define two mappings m and l as follows: Mapping m: index of column of A→index of column of A₀; the jth column of A is the m(j) th column of A₀ and m(j)≠m(k) for j≠k. m maps the same mineral standards from A to A₀. m(j) can be φ (an empty set) and this null mapping happens if there is no corresponding mineral in A₀ such as pyrite and barite. For an index j corresponding to one of such minerals,

aⱼ=aₘ₍ⱼ₎⁰=a_{φ}⁰=0.

Mapping l: index of column of F→index of column of F₀; the jth column of F is the l(j)th column of F₀. l maps the same mineral compositions from F to F₀. l(j) can be φ (no mapping). For example, for kerogen there are no definite elemental concentrations as its chemical composition cannot be uniquely defined. Also note that l(j) and l(k) can be the same for j k; for example, two different types of calcium carbonate having different standard spectra in DRIFTS and having the same elemental concentrations, CaCO₃.

Now, we use the index set I, which is a set of indices corresponding to common minerals between two different measurement systems in terms of the vector z. Then, we obtain the following observation parts, given that index ordering for x (DRIFTS solution) is the same as for z (the joint solution) in I.

For DRIFTS,

$$\begin{matrix}{\sum }_{i ∈ I} {a}_{i} {z}_{i} = {\sum }_{i ∈ I} {a}_{m ( i )}^{0} {z}_{m ( i )} & ( 23 ) \\ = {\sum }_{i ∈ I} {a}_{m ( i )}^{0} {x}_{m ( i )} & ( 24 )\end{matrix}$$

For XRF,

$$\begin{matrix}{\sum }_{i ∈ I} {f}_{i} {z}_{i} = {\sum }_{i ∈ I} {f}_{l ( i )}^{0} {z}_{l ( i )} & ( 25 ) \\ = {\sum }_{i ∈ I} {f}_{l ( i )}^{0} {x}_{l ( i )} & ( 26 )\end{matrix}$$

Therefore, we can relate some part of the joint solution z with the mapped part of the compensated XRF-only solution, My, by using the mapping function l:

$${\sum }_{i ∈ I} {f}_{i} {z}_{i} = {\sum }_{k ∈ {l}^{- 1} ( I )} {f}_{k}^{0} {My}_{k} , \qquad ( 27 )$$

where this equality considers only common minerals, and l⁻¹ is the inverse mapping of l. Consequently, the term in (26) should be also equal to

$${\sum }_{i ∈ I} {f}_{l ( i )}^{0} {x}_{l ( i )} = {\sum }_{k ∈ {l}^{- 1} ( I )} {f}_{k}^{0} {My}_{k} , \qquad ( 28 )$$

In practice, we evaluate an estimator:

$${\hat{M}}_{k} = {\sum }_{i \text{:} l ( i ) = k} {\hat{x}}_{i} / {\hat{y}}_{k} \qquad ( 30 )$$

for iεI and a certain k (mineral) or its averaged version for several k values to obtain a stable solution. In this equation, we denote the estimates from noisy data with the hat symbol. This estimate can be considered as the ratio of the weight fraction of mineral k from the DRIFTS-only solution to the weight fraction of mineral k from the XRF-only solution. Averaging or taking the median value of Mk is recommended because noisy data would produce different values of Mk. Applying M to XRF data is equivalent to applying l/M to DRIFTS data. Therefore, to apply both the DRIFTS scaling and the ‘solution matching’ compensations, we can simply apply L/M to DRIFTS data.

Using Variable Elemental Concentrations to Constrain Mineralogy Solutions.

Several minerals, such as illite and other clay minerals, have multiple elemental concentrations. The elemental concentrations in these minerals span a limited, but continuous (i.e., non-discrete), range. The maximum weight fraction of an element in a mineral, known from mineral stoichiometry, can provide upper limits on the concentration of the minerals containing that element. In this case, the maximum bound for the jth mineral can be found through two steps. First, evaluate the maximum of the mineral fractions from the measurement of the ith element and all possible weight fractions of the ith element in jth mineral (i.e., the concentration of ith element can be variable in clay minerals). Second, evaluate the maximum of the weight fractions of the jth mineral obtained in step one. The algorithm can be formulated as follows:

$${y}_{j}^{MA X} = {max}_{i} max \{ 0 \leq {y}_{j} \leq 1 \text{:} {\tilde{f}}_{i}^{0} y \leq {d}_{i} + {δ}_{i} , for all chemical compositions in {F}_{0} \} , \qquad ( 31 )$$

where i is the index of elements, \hat{f}ᵢ⁰ is the ith row vector from F₀, di is the ith entry of d, and δᵢ is the uncertainty level for the ith element. Eq. (31) calculates the maximum of the feasible solution sets for the mineralogy vector y after constraining the maximum allowed mineral fractions calculated from the chemical data. The constraints for the joint solution variable z can be found by using the mapping 1 (mapping from mineral indices of F to mineral indices of F₀).

We demonstrate this constraint by way of an example using illite. Mite may have a composition given by the empirical formula: K_{0.6}(Al_{0.8}Mg_{0.3}Fe_{0.1})(Si_{3.5}Al_{0.5})O₁₀(OH)₂(H₂O). We denote this illite, ‘Illite1’. Illite1 contains 1.87 wt % Mg and 1.43 wt % Fe. Table 2 lists the weight concentrations of the elements in Illite1. It is possible for illite to contain different concentrations of the substituting elements, in this example Fe and Mg. In the case that Mg nearly entirely substitutes in the place of Fe, illite may have a composition given by the formula, K_{0.5}(Al_{1.0}Mg_{0.48}Fe_{0.02})(Si_{3.5}Al_{0.5})O₁₀(OH)₂(H₂O). We call it ‘Illlite2’ and it contains 3.05 wt % Mg and 0.29 wt % Fe (Table 2).

TABLE 2
Elemental compositions of hypothetical Illite1 and Illite2

| Element, | | |
|---|---|---|
| wt % | Illite1 | Illite2 |
| K | 6.02 | 5.12 |
| Al | 11.07 | 10.59 |
| Mg | 1.87 | 3.05 |
| Fe | 1.43 | 0.29 |
| Si | 25.22 | 25.72 |
| O | 53.35 | 54.43 |
| H | 1.03 | 0.79 |
| Total | 100.00 | 100.00 |

Now, consider a sample containing illite that has the following elemental concentrations quantified by XRF: 1.65 wt % Mg and 0.2 wt % Fe. The maximum concentration of illite in this sample, considering the two composition profiles for Illite1 and Illite2 above, is calculated as:

$$\begin{matrix}{y}_{illite , Mg}^{MA X} = max \{ \frac{measured Mg}{Mg fraction in illite 1} , \frac{measured Mg}{Mg fraction in illite 2} \} & ( 32 ) \\ = max \{ \frac{1.65}{1.87} , \frac{1.65}{3.05} \} & ( 33 ) \\ = max \{ 88.2 \% , 54.0 \% \} & ( 34 ) \\ = 88.2 \% . & ( 35 ) \\ {y}_{illite , Fe}^{MA X} = max \{ \frac{measured Fe}{Fe fraction in illite 1} , \frac{measured Fe}{Fe fraction in illite 2} \} & ( 36 ) \\ = max \{ \frac{0.20}{1.43} , \frac{0.20}{0.29} \} & ( 37 ) \\ = max \{ 14.0 \% , 69.0 \% \} & ( 38 ) \\ = 69.0 \% & ( 39 )\end{matrix}$$

### Therefore,

yᵢₗₗᵢₜₑ^{MAX}=max{_{illite,Mg}^{MAX},_{illite,Fe}^{MAX}}=max {882%667%}=88.2 wt % (40)

The maximum content of illite in this example is 88.2 wt %, unless other elements provide larger estimates. In practice, illite can have more diverse elemental concentrations than the two illites described above. Therefore, all possible elemental concentrations of illite should be considered to produce maximum and minimum bounds.

Similar arguments can be used to constrain the minimum concentration of minerals in a sample. We consider several possible arguments:

1. A single mineral m in the sample contains the element p in a fixed concentration (e.g., considering here barium being present in barite). No other minerals in this sample contain p. Then the weight concentration of p estimated from XRF can be used to estimate the minimum concentration of the mineral m:

$${y}_{m} = \frac{weight percent of element p in XRF data}{weight percent of the element p in mineral m} . \qquad ( 41 )$$

2. Multiple minerals in the sample contain the element p. The concentration of p in individual minerals m may vary within a defined range. For example, illite and smectite contain aluminum, but the concentration of Al in illite and smectite is not exactly fixed. The measured element weight concentration of p is zero. In this case, the weight concentrations of the minerals containing element p are zero. Therefore, the minimum for these minerals is zero.

3. Multiple minerals in the sample contain the element p. The concentration of p in individual minerals m may vary within a defined range. The measured element weight concentration of p is greater than zero. In this case, we can evaluate the infimum (minimum) similarly to Eq. (31). For illustration, we follow the above example having Illite1 and Illite2.

$${y}_{j}^{MI N} = {min}_{i} min \{ 0 \leq {y}_{j} \leq 1 \text{:} {\tilde{f}}_{i}^{0} y \geq {d}_{i} - {δ}_{i} , for all chemical compositions in {F}_{0} \} \qquad ( 42 )$$

Therefore, the minimum for illite in the above example is:

yᵢₗₗᵢₜₑ^{MIN}=min{88.2%,54.0%,14.0%,69.0%}=14.0 wt % (43)

4. One or more minerals in the sample may contain the element p. The concentration of p in individual minerals m is not fixed and may be zero. No constraint can be derived for the minimum concentration of mineral m (except positivity), because the mineral m does not need to contain element p. Therefore, the minimum for these minerals is zero.

Inversion Models Using Constraints

We have described in detail the general framework for the joint inversion of two or more data types (e.g., DRIFTS and XRF) considering optional constraints from variable mineral compositions. Other embodiments of the subject disclosure include, but are not limited to:

According to some embodiments, the inversion of DRIFTS-only data with constraints from XRF data as defined in Eqs. (31) and (42) is described. In this case there is no XRF-related inversion. Therefore, the set of quantifiable minerals is the same as that from DRIFTS-only inversion.

According to some embodiments, a variation on Method 2 is described comprising two parts. Part one is the DRIFTS-only inversion for a set of minerals quantifiable by DRIFTS alone, using constraints from variable, but defined, mineral compositions and independent chemical data. Part two is the separate quantification of additional minerals, which are otherwise not solved for by the DRIFTS-only inversion, using chemical data. For example, the solution is a combination of the mineralogy vector estimated from the DRIFTS-only inversion (part one) and the mineralogy vector for additional minerals (e.g., pyrite and barite) estimated from XRF data (part two). Both parts use defined elemental concentrations of minerals.

According to some further embodiments, a joint inversion method that partially uses the constraints from variable but defined elemental concentrations for a predefined set of minerals solved by the joint inversion is disclosed. This method is a combination of the above inversion methods. We put constraints for a certain mineral m in the proposed joint inversion and eliminate the related part of the XRF inversion. For example, if the bounds obtained from chemistry information are used as constraints for a certain mineral m, then the corresponding column of F is set to a zero vector. Therefore, there is no XRF-related inversion for this mineral m.

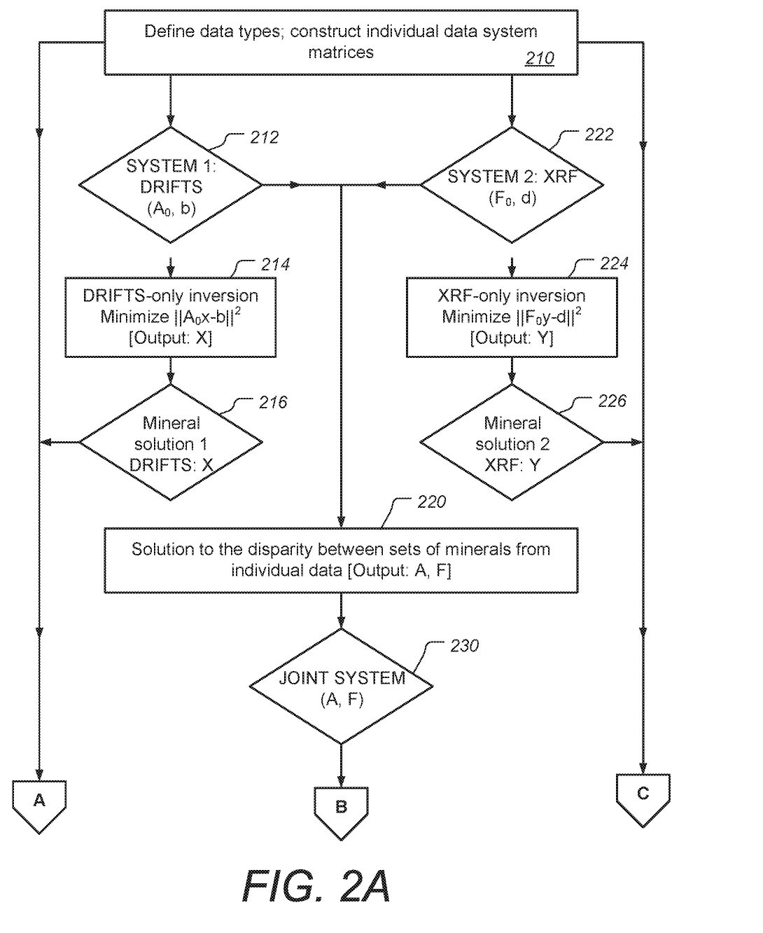

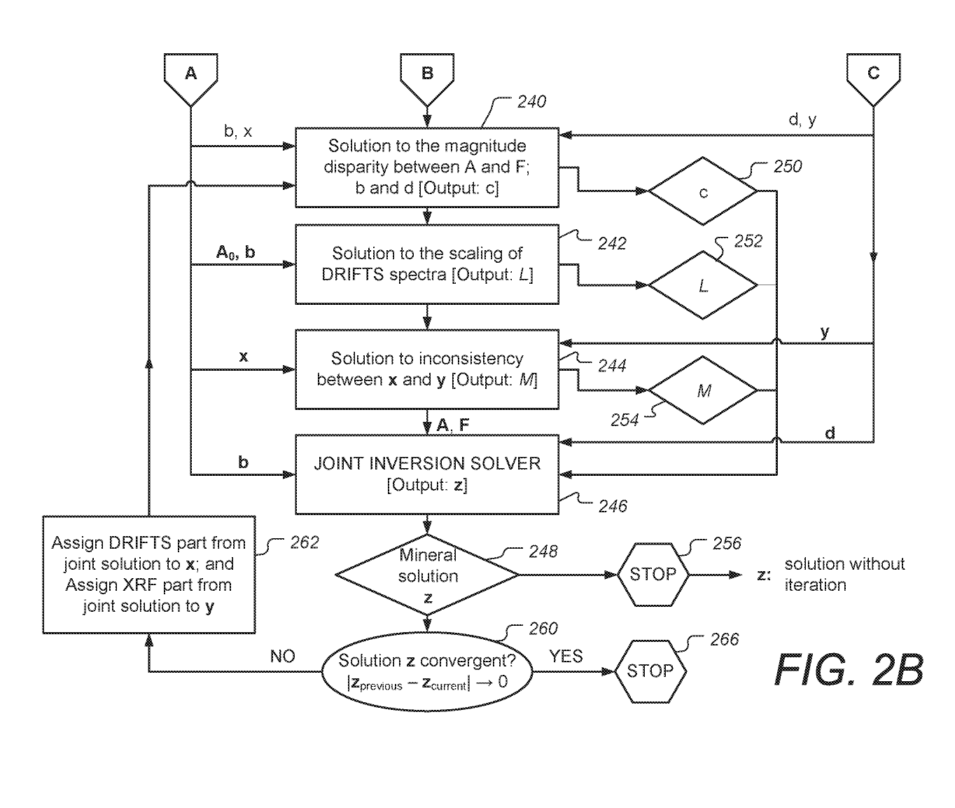

FIGS. 2A and 2B are a flow diagram illustrating aspects of a joint inversion of multiple data types to yield a consistent mineralogy solution, according to some embodiments. The flowchart shows the methodology for the joint inversion of two systems (DRIFTS and XRF) and their data. Although the example shown the systems and data types are DRIFTS and XRF, the framework is general such that the methodology can be applied to additional data types (such as FTIR, ATR, XRD, etc).

The following notation is used:
A₀: a matrix of DRIFTS mineral standard spectra;
b: a measured DRIFTS spectrum;
F₀: a matrix of element weight fractions of the minerals;
d: the weight fractions of elements measured by XRF spectroscopy;
x: DRIFTS-only mineral solution;
y: XRF-only mineral solution;
A: expanded DRIFTS system matrix from A₀ addressing disparity between sets of minerals in DRIFTS and XRF;
F: expanded XRF system matrix from F₀ addressing disparity between sets of minerals in DRIFTS and XRF;
c: solution to magnitude disparity between A and F; b and d;
L: solution to the scaling of DRIFTS spectrum;
M: solution to the inconsistency between x and y;
z: joint mineral solution;
z_{current}: current joint solution; and
zₚᵣₑᵥᵢₒᵤₛ: current joint solution.

In block 210, the data types are defined and individual data system matrices are constructed. In this particular example, SYSTEM 1 (212) is DRIFTS, and SYSTEM 2 (222) is XRF. The DRIFTS-only mineral solution (x) and the XRF-only mineral solution (y) are estimated as initial guesses prior to the joint inversion. In blocks 214 and 224 the individual system inversions for DRIFTS and XRF, respectively, are carried out. The inversions yield mineral solutions 216 and 226 for DRIFTS and XRF, respectively. The individual system matrices, A₀ and F₀, for DRIFTS and XRF, respectively, may contain different sets of minerals. In block 220, the individual system matrices, A₀ and F₀, are expanded to resolve this disparity and to obtain consistent system matrices, A and F, for the joint inversion (i.e., the set of minerals in the two sub-system matrices A and F used in the joint inversion are identical). The expanded system matrices (A and F) from the two individual systems 212 and 222 are processed in the Joint System 230. The expanded system matrices (A and F) and the measurements/observations (b and d) may have a magnitude disparity, which is solved in block 240 as a weight/balancing factor on the XRF data, c. The individual DRIFTS spectra may be subject to enhancement or attenuation, such that the absolute mineral weight concentrations (fractions) in x does not sum to one, although the relative mineral concentrations are robust. A scaling factor, L, is now computed from the DRIFTS system (A₀, b, x), in block 242, to resolve this disparity. The subsequent block 244 in the workflow is to resolve any inconsistencies among the individual solutions (x and y) by computing the ‘solution-matching’ factor, M (i.e., illite concentration in x should be the same as or close to that in y). M is computed from the available information common among individual systems. Having resolved any disparities between data types, the next block 246 runs the joint inversion of multiple data. The inputs to the joint inversion are the expanded system matrices (A, F), the multiple measurements/observations (b, d), and the computed factors, c, L, and M. The output from the joint inversion is the solution z, the vector of mineral weight fractions. According to some embodiments, the process is stopped (256) without iteration. According to some other embodiments, however, the current solution z is iterated, producing a new set of results z′, until a convergent solution is obtained. In block 260 a decision is made whether or not to perform further iterations. If a further iteration will be carried out, in block 262 the joint solutions to x and y are assigned to the DRIFTS and XRF parts, respectively, and the blocks 240, 242, 244 and 246 are processed again. According to some embodiments, the decision 260 whether or not to terminate the process with a final mineralogy solution z can be made based on a number of criteria, including:

1. The sum of mineral weight fractions in z is close to one. A threshold deviation from sum of z equal to one may be used to define the acceptance criterion; for example, sum of z within 5% relative of one.

2. The DRIFTS misfit from the joint inversion is within a specified limit of deviation from the misfit calculated from the DRIFTS-only inversion (∥b−A\hat{x}∥²). For example, the limit of deviation between the two misfits could be 5% relative, 10% relative, or other.

3. A partial DRIFTS misfit (i.e., the misfit for a specified region of the DRIFTS spectrum) is within a specified limit of deviation from the misfit from the DRIFTS-only inversion for the same part of the spectrum. For example, the limit of deviation between the two misfits could be 5% relative, 10% relative, or other. A specified part of the spectrum can be selected according to the minerals of interest. For example, the misfit can be calculated in the region of 2800-3400 cm⁻¹ of the DRIFTS spectrum.

4. The number of iterations that have been carried out for the joint inversions is greater than a specified number. This number of iterations can be any integer greater than zero.

Note that any combinations of these criteria or others can be used. For example, a criteria to terminate the process can be the condition of both 1 and 4; both of the criteria in 1 and 4 is satisfied. Another criteria to terminate the process could be the condition (1 and 2) or 4; the criteria in both 1 and 2 are satisfied, or the criteria in 4 is satisfied.

Further Extension of the General Inversion Framework.

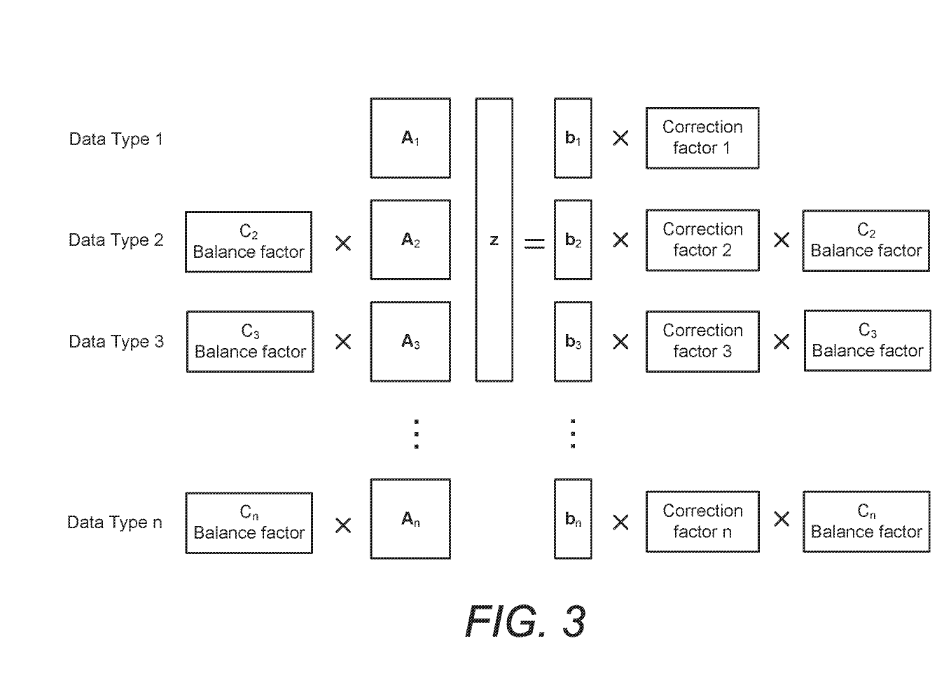

FIG. 3 is a schematic diagram illustrating the extension of the proposed joint inversion framework to further data types, according to some embodiments. According to some embodiments, the joint inversion framework is extended to include other types of data in addition to DRIFTS and XRF described in detail herein. Examples of additional data types with which the described techniques can be applied include, but are not limited to: (1) infrared spectroscopy techniques such as Transmission Fourier transform IR (FTIR) spectroscopy and Attenuated total reflection (ATR or ATR-IR) spectroscopy; and (2) X-ray methods such as X-ray diffraction (XRD). Further examples of additional data types with which the described techniques can be applied include, but are not limited to the following elemental analysis techniques: (1) mass spectrometry techniques (separating and quantifying elements according to their mass) e.g. Inductively coupled plasma mass spectrometry (ICP-MS); and (2) spectroscopy techniques (separating and quantifying elements according to their electromagnetic properties, wavelength, or energy) e.g. X-ray fluorescence (XRF) (X-ray excitation of elements and detection of secondary X-rays), Inductively coupled plasma atomic emission spectroscopy/optical emission spectroscopy (ICP-QES, or ICP-OES), Atomic absorption spectroscopy (AAS) (quantification of light absorption by element of interest in gaseous state), and Neutron activation analysis (NAA) (excitation by neutron and detection of emitted gamma rays).

The described framework can also be applied to logging data, such as geochemical and other logs, to quantify more minerals than presently possible. This extension can be implemented by substituting the model described by Eq. (1) with a model comprising the appropriate downhole logs and by substituting the model described by Eq. (2) with other data from downhole logs, core, cuttings, or other sources.

In FIG. 3, the inversion has n number of individual data types, where n>2. The ith data type, where i=1, . . . , n, has the system matrix Ai and observation bi as shown in FIG. 3. According to some embodiments described in detail above, Ai is a DRIFTS system matrix containing the DRIFTS mineral standards spectra in column form and bi is the measured DRIFTS spectra. A₂ is the mineral-element composition table for an XRF system matrix, and b₂ is the measured elemental concentration data (i.e., element weight concentrations). Inclusion of other data types is done by adding their respective system matrices and measurements. For example, A₃, b₃ can be respectively the system matrix and measurements for ATR. Likewise, A₄, b₄, can be respectively the system matrix and observations for FTIR, and A₅, b₅ can be the system matrix and observations, respectively, for XRD. The balance factor cᵢ can be found by solving for the ratio of the noise levels in system 1 (DRIFTS) and system i. A system may require correction factors such as L, Min the compensated DRIFTS system. These correction factors depend on the physics inherent to the different data types. As a consequence, individual estimation strategy should be considered for each data type to determine the need for or the type of correction factors.

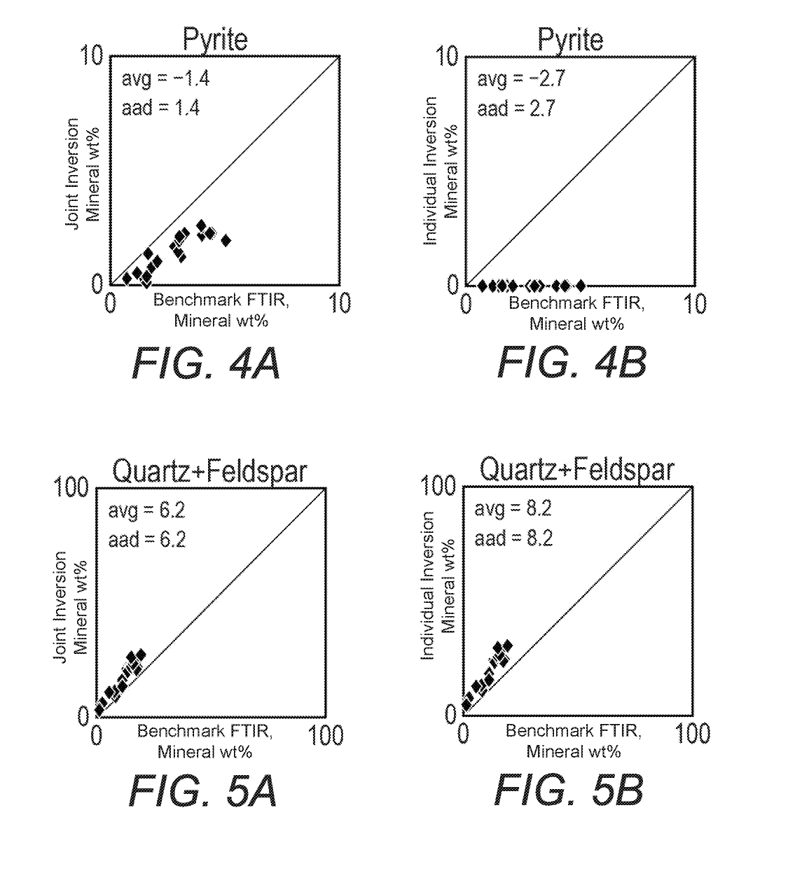

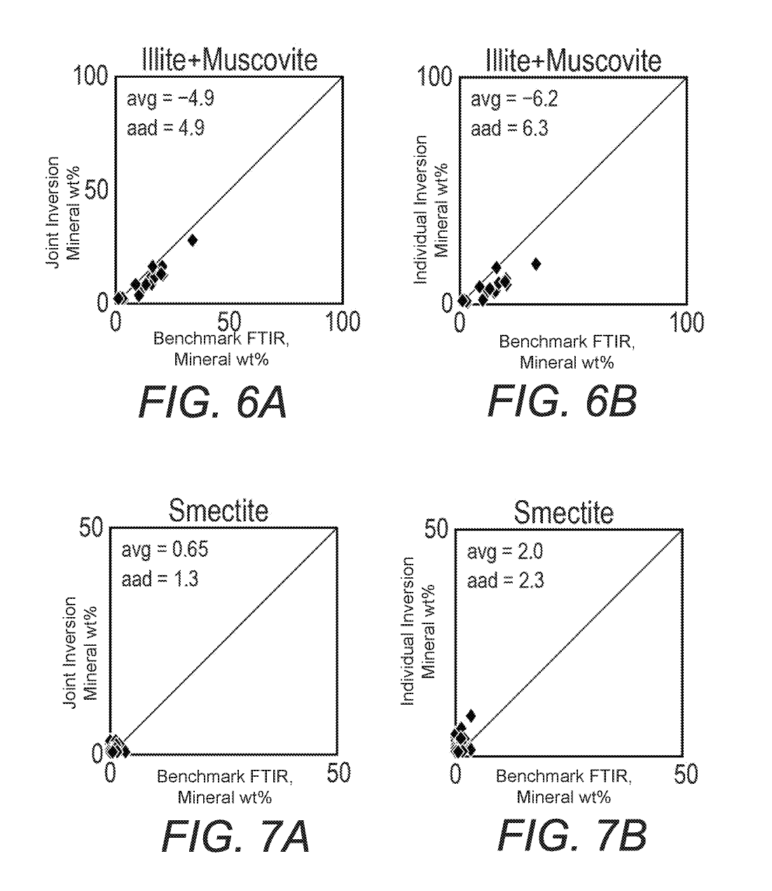

FIGS. 4A-4B, 5A-5B, 6A-6B and 7A-7B are plots showing results of a case study comparing results from a joint inversion techniques and conventional single system inversions, according to some embodiments. The case study demonstrates that the joint inversion method works in cases for which the chemical data is acquired using a field-portable XRF instrument that yields data with reduced accuracy compared to high-end laboratory XRF instruments. Note that the DRIFTS technique is already field-portable and thus this case study exemplifies the results achievable using the methods disclosed.

FIG. 4A shows mineral weight % for pyrite calculated using a joint inversion technique (in this case, DRIFTS+XRF) plotted against a benchmark transmission FTIR spectroscopy laboratory method. Also shown is the average deviation and absolute average deviation from the benchmark values. FIG. 4B shows the results for pyrite using a conventional individual inversion technique (in this case, DRIFT only). As is shown, pyrite can be quantified using the joint inversion method, whereas pyrite was not quantifiable from the individual inversion model. Similarly, FIGS. 5A and 5B, 6A and 6B, and 7A and 7B compare joint inversion vs. individual inversion results for quartz plus feldspar, illite plus muscovite, and smectite, respectively. These results show that the addition of a second data measurement (in this case, XRF) expands the mineralogy solution compared to the individual (in this case, DRIFTS-only) inversion method. In addition, the joint inversion can improve the accuracy of the bulk mineral solution on average.

Some of the methods and processes described above, including processes, as listed above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general purpose computer) for executing any of the methods and processes described above.

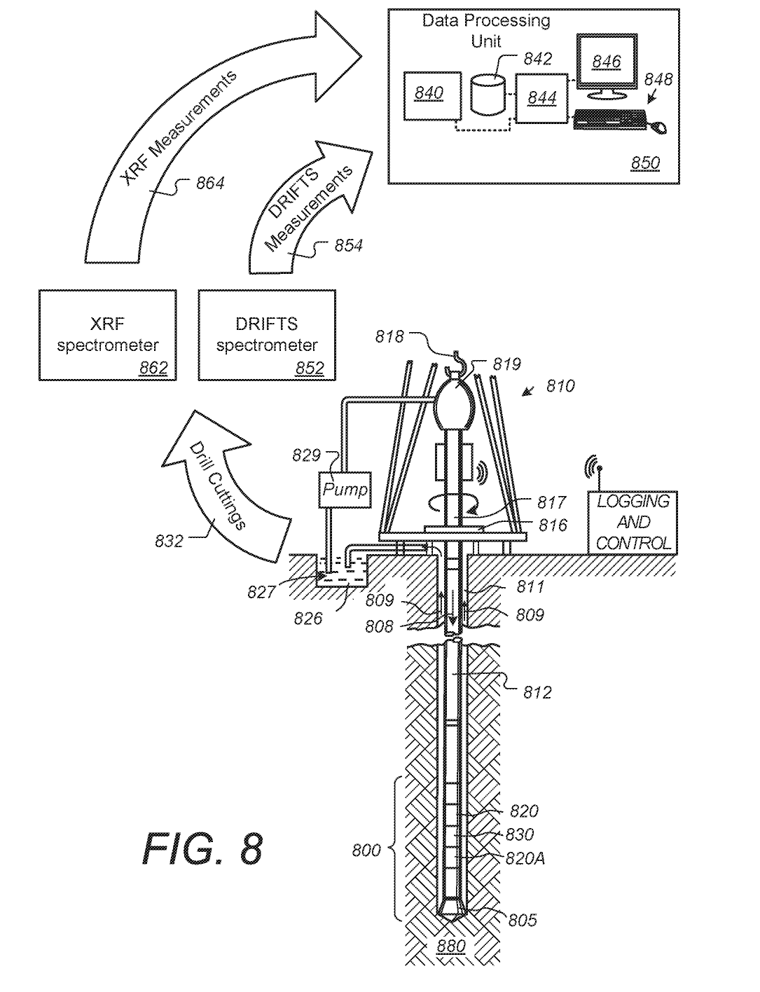

FIG. 8 illustrates a wellsite system in which elements and/or minerals in a hydrocarbon-bearing rock formation are quantified using multiple data types measured on samples taken from the well, according to some embodiments. The wellsite is depicted on land, although the wellsite can be onshore or offshore. In this system, a second well 811 is formed in subsurface formation 880 by rotary drilling in a manner that is well known. Embodiments of the subject disclosure can also use directional drilling. According to some embodiments, rock formation 880 is a hydrocarbon-bearing sedimentary rock formation. According to some other embodiments, the formation 880 is 100% water wet, at the location shown in FIG. 8.

A drill string 812 is suspended within the borehole 811 and has a bottom hole assembly 800 that includes a drill bit 805 at its lower end. The surface system includes platform and derrick assembly 810 positioned over the borehole 811, the assembly 810 including a rotary table 816, kelly 817, hook 818 and rotary swivel 819. The drill string 812 is rotated by the rotary table 816, energized by means not shown, which engages the kelly 817 at the upper end of the drill string. The drill string 812 is suspended from a hook 818, attached to a traveling block (also not shown), through the kelly 817 and a rotary swivel 819, which permits rotation of the drill string relative to the hook. As is well known, a top drive system could alternatively be used.

In the example of this embodiment, the surface system further includes drilling fluid or mud 826, stored in a pit 827 formed at the well site. A pump 829 delivers the drilling fluid 826 to the interior of the drill string 812 via a port in the swivel 819, causing the drilling fluid to flow downwardly through the drill string 812, as indicated by the directional arrow 808. The drilling fluid exits the drill string 812 via ports in the drill bit 805, and then circulates upwardly through the annulus region between the outside of the drill string and the wall of the borehole, as indicated by the directional arrows 809. In this well-known manner, the drilling fluid lubricates the drill bit 805 and carries formation cuttings up to the surface as it is returned to the pit 827 for recirculation.

The bottom hole assembly 800 of the illustrated embodiment contains a logging-while-drilling (LWD) module 820, a measuring-while-drilling (MWD) module 830, a rotary-steerable system and motor, and drill bit 805.

The LWD module 820 is housed in a special type of drill collar, as is known in the art, and can contain one or a plurality of known types of logging tools. It will also be understood that more than one LWD and/or MWD module can be employed, e.g. as represented at 820A. (References throughout, to a module at the position of 820, can alternatively mean a module at the position of 820A as well.) The LWD module includes capabilities for measuring, processing, and storing information, as well as for communicating with the surface equipment. In the present embodiment, the LWD module includes a resistivity measuring device as well as a number of other devices, such as a neutron-density measuring device, and a multipole sonic measuring device.

The MWD module 830 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

According to some embodiments, drill cuttings 832 are taken from the drilling mud, cleaned and analyzed using a DRIFTS spectrometer 852 and an XRF spectrometer 862. Note that both DRIFTS spectrometer 852 and XRF spectrometer 862 receives drill cuttings 832. After sample preparation (e.g. washing and/or particle size modification) the DRIFTS spectrometer generates DRIFTS data 854 and the XRF spectrometer generates XRF data 864. Both types of data are processed and interpreted in processing unit 850. Processing unit 850 uses a technique such as shown in FIGS. 2A and 2B that includes a joint-inversion of both DRIFTS data 854 and XRF data 864 to quantify elements and/or minerals in the rock formation 880. The processing unit 850 includes one or more central processing units 844, storage system 842, communications and input/output modules 840, a user display 846 and a user input system 848. Storage system 842 may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

According to some embodiments, the measurement systems 852 and 862, and the processing system 850 are located at the wellsite such as a logging truck or at some other location at the wellsite. In such cases the measurement and joint inversion techniques can be carried out in real-time during the drilling process. Providing this type of rapid formation evaluation has potential benefits in well completion decisions, for example, for the optimal placement of perforations and hydraulic fractures. There may also be potential applications for geosteering.

According to some other embodiments, data processing unit 850 and/or the spectrometers 852 and 862 are located at one or more locations remote from the wellsite such as at a remote laboratory. At a remote laboratory, additional and more accurate/complex characterization methods can be included in the joint inversion framework to provide better accuracy and resolution of the sample mineralogy and/or other formation properties.

Although the two types of data in FIG. 8 are shown to be DRIFTS and XRF, according to some embodiments other types of data can be used and also more than two types of data can be used, such as shown and described with respect to FIG. 3. Although drill cuttings are used as the sample in FIG. 8, according to some embodiments other types of physical material samples of the subterranean rock formation can be used such as core samples.

Some of the methods and processes described above, as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for analyzing samples from a subterranean rock formation comprising:
receiving a physical sample of the rock formation obtained from a borehole traversing the rock formation;
performing a first measurement technique that includes making a first measurement on at least a portion of the sample;
performing a second measurement technique that includes making a second measurement on at least a portion of the sample; and
detecting the presence of one or more elements or minerals in the sample based on a combination of the first and second measurement techniques, wherein said detecting is with greater accuracy than or would not have been possible using either the first or second measurement techniques alone.

2. The method of claim 1 in which the detecting further comprises quantifying one or more elements or minerals in the sample with greater accuracy than would have been possible using either the first or second measurement techniques alone.

3. The method of claim 1 in which the one or more elements or minerals includes one or more organic chemical compounds.

4. The method of claim 3 in which the one or more organic chemical compounds are selected from a group consisting of: kerogen, oil and bitumen.

5. The method of claim 1 in which the first measurement technique is DRIFTS spectroscopy and the second measurement technique is XRF spectroscopy.

6. The method of claim 1 in which the first and second measurement techniques are selected from a group consisting of: DRIFTS; XRF; transmission Fourier transform IR (FTIR) spectroscopy; attenuated total reflection (ATR or ATR-IR) spectroscopy; X-ray diffraction (XRD); mass spectrometry; inductively coupled plasma atomic emission spectroscopy/optical emission spectroscopy (ICP-QES, or ICP-OES); atomic absorption spectroscopy (AAS); and neutron activation analysis (NAA).

7. The method of claim 1 further comprising performing a third measurement technique that includes making a third measurement on at least a portion of the sample, and wherein the detecting is further based on a combination of the first, second and third measurement techniques.

8. The method of claim 1 in which the combination of the first and second measurement techniques includes a joint inversion of the first and second measurements.

9. The method of claim 8 in which one or both of the first and second measurements are inverted individually prior to the joint inversion.

10. The method of claim 2 further comprising comparing the quantified one or more elements or minerals with data from the first measurement and with data from the second measurement.

11. The method of claim 1 in which the combination of the first and second measurement techniques is an inversion of data from the first measurement constrained by data from the second measurement.

12. The method of claim 1 in which the first measurement type relies on a linear relationship between the first measurement and a quantity of a mineral or element and the second measurement type relies on a linear relationship between the second measurement and a quantity of a mineral or element.

13. The method of claim 1 in which the rock formation is sedimentary hydrocarbon-bearing rock formation.

14. The method of claim 1 in which the physical sample collected is from drill cuttings and/or core sampling.

15. The method of claim 1 in which the method is carried out at a wellsite location.

16. The method of claim 15 in which the method is carried out in real-time during a drilling operation.

17. The method of claim 1 in which the method is carried out in a laboratory remote from the borehole location.

18. A system for analyzing a sample from a subterranean rock formation comprising:
a first measurement system configured to perform a first measurement type on a physical sample of the rock formation obtained from a borehole traversing the rock formation;
a second measurement system configured to perform a second measurement type on the physical sample; and
a processing system configured to detect the presence of one or more elements or minerals in the sample based on a combination of a first measurement from the first measurement system and a second measurement from the second measurement system, wherein said detecting is with greater accuracy than or would not have been possible using either the first or second measurement systems alone.

19. The system of claim 18 in which the processing system is further configured to quantify the one or more elements or minerals in the sample with greater accuracy than would have been possible using either the first or second measurement systems alone.

20. The system of claim 18 in which the one or more elements or minerals includes one or more organic chemical compounds.

21. The system of claim 18 in which the first and second measurement systems are of types selected from a group consisting of: DRIFTS; XRF; transmission Fourier transform IR (FTIR) spectroscopy; attenuated total reflection (ATR or ATR-IR) spectroscopy; X-ray diffraction (XRD); mass spectrometry; inductively coupled plasma atomic emission spectroscopy/optical emission spectroscopy (ICP-QES, or ICP-OES); atomic absorption spectroscopy (AAS); and neutron activation analysis (NAA).

22. The system of claim 18 in which the combination of the first and second measurements includes a joint inversion of the first and second measurements.

23. The system of claim 22 in which one or both of the first and second measurements are inverted individually prior to the joint inversion.

24. The system of claim 18 in which the physical sample is collected from drill cuttings and/or core sampling, and the system is configured for deployment at a wellsite location and the detection to be carried out is in real-time during a drilling operation.
